(19) United States
(12) Patent Application Publication
(10) Pub. No.: US 2005/0205723 A1
(43) Pub. Date: Sep. 22, 2005

(54) Holder for electrical lines and tubes

(75) Inventors: Lutz Zeuner, Hardebek (DE); Hans-Georg Plate, Roseburg (DE); Lueder Kosiankowski, Jork (DE); Hans-Peter Guthke, Buxtehude (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/073,992

(22) Filed: Mar. 7, 2005

Related U.S. Application Data
(60) Provisional application No. 60/598,242, filed on Aug. 3, 2004.

(30) Foreign Application Priority Data
Mar. 8, 2004 (DE) 10 2004 011 185.5

(51) Int. Cl. F16L 3/24

(52) U.S. Cl. 248/72; 248/228.8

(57) ABSTRACT

The present invention relates to a holder for fastening lines and tubes to a support in aircraft, comprising a base body and at least one slide-in unit. In this connection, the base body has a recess for receiving the slide-in unit. The slide-in unit is held in an end position in the recess. The base body is mountable by means of the slide-in unit to the support. The holder is formed to receive lines and tubes having a diameter in the order of magnitude of 30 to 50 mm thickness.

### CROSS-REFERENCE TO RELATED APPLICATIONS

This application claims the benefit of the filing date of U.S. Provisional Patent Application No. 60/598,242 filed Aug. 3, 2004, the disclosure of which is hereby incorporated herein by reference.

### BACKGROUND OF THE INVENTION

The present invention relates to a holder for lines or line routes in aircraft, as well as a corresponding method.

For local attachment of at least one line to a component, many forms of holders are known. These types of holders are used in air and space travel, in particular, to run lines, bundles of lines, and tubes. In the state of the art, holders for attaching electrical lines or guiding electrical line bundles are used in different areas.

The holders in the state of the art are attached by screwing to the transverse carrier or frame. Upon mounting with the aid of this holder, the problem exists that the available holder must be screwed in.

A further disadvantage of these holders is that the holders must be adapted to the concrete conditions of connection onto the transverse carrier or frame (former), for example, taking into consideration the thickness of the bars of the transverse carrier or the bore diameter.

In addition, in aircraft construction today, no holders for larger diameters are known. Line bundles of 25 mm and more, which are frequently required in aircraft technology, cannot be laid with the holders available in the state of the art.

### SUMMARY OF THE INVENTION

According to an exemplary embodiment of the invention, a holder for fastening of lines to a support in aircraft is provided, including a base body and at least one slide-in unit. The base body may have a recess for receiving the slide-in unit, and the slide-in unit may be held in an end position in the recess. The base body may be mountable by means of the slide-in unit onto the support, and the base body may be formed to receive lines with a diameter of 25 to 50 mm thickness.

As lines, according to the invention, current conducting materials are designated, which make possible the transmission of electricity from one location to another. Also bus lines are included. Depending on the current which is to be transmitted, therefore, different lines of different shapes and different weights can be used. When thicker materials are used for higher currents, this makes placement of these materials more difficult, since these thicker materials are more difficult to bend or deform. Likewise, under the term “lines”, a line bundle, tubes, air conditioning pipes, and water pipes, etc., can be included. In other words, the term “lines” includes tubes, air conditioning pipes, and water pipes, etc.

According to one embodiment of the present invention, a holder for an aircraft is provided, which simplifies the local attachment of lines to a support. As a support, particularly an elongated, supportive structure is designated. This can be a T-support or a double-T support, for example. The support may be reinforced, in order to be able to support higher loads. The holder of this embodiment may include a base body and a slide-in unit. The part, which is not guided into the recess of the base body, may lie, then, when the slide-in unit has reached its end position in the base unit, directly on the belt of the support. The base body and the slide-in unit may encompass the belt of the support. The holder therefore may sit firmly on the support. Therefore, a vertical side of the slide-in unit may lie on the vertical side of the belt or chord, the two attached horizontal sides of the slide-in unit may terminate directly over or under the vertical sides of the support. Thus, the base body is fixedly connected with the support when the slide-in unit is guided into the recess provided for this purpose. According to an exemplary embodiment of the present invention, an improved holder for aircraft is thus provided.

The inner part of the base body may have a recess. This recess can be flat or structured so that, for example, by the application of horizontal groovings or similarly structured depressions, a better hold of the slide-in during insertion into the recess can be achieved. According to this exemplary embodiment of the present invention, the holder is manufactured, such that it can accommodate lines or also line skeins having a diameter with a size of 30 to 50 mm thickness. The large line skeins or strands can therefore be laid down during mounting in an arm of the base body. The line premounted in this manner or the premounted line skein can be aligned and fixed by means of a cable tie or binder.

In a further exemplary embodiment, the holder may be made such that it can be fixed by means of a pin to the support. The pin thereby may prevent displacement of the base body, such as, for example, an axial displacement.

In a further exemplary embodiment of the invention, the holder is made, such that the retention of the slide-in unit is realized by means of a clip fastener.

In another exemplary embodiment, the base body and slide-in unit are made of essentially one material. This material may be plastic. For example, the base body and the slide-in unit can be made by an injection molding method. The base body and slide-in unit also can be made from plastic, and at the same time, have a reinforced structure of metal. This can be advantageous, in particular, when lines of larger diameter and higher net weight are to be laid. The base body and slide-in unit, however, also can be made from metal and have additional structures made of plastic. This can be appropriate when the parts that are in direct contact with the lines have properties of a plastic structure, which lead to a greater gripping of the structure for the lines and, for example, prevent slipping of the lines.

In another exemplary embodiment of the present invention, a method for placing lines on a support, in particular in aircraft, by means of a holder is provided, wherein the holder may essentially comprise a base body and a slide-in unit; the method may include the steps of inserting the slide-in unit into the corresponding recess of the base body, which the base body may have for accommodating the slide-in unit, and holding the slide-in unit in an end position in the recess, wherein the holder may be formed such that the lines with a diameter of 25 to 50 mm thickness can be accommodated.

In a further exemplary embodiment, a use of a holder for attaching lines to a support is provided, wherein the holder may essentially include a base body and a slide-in unit, and the base body may have a recess for accommodating the slide-in unit, and the slide-in unit may be held in an end position in the recess. This use of the holder may make possible accommodating lines having a diameter of 25 to 50 mm thickness.

In a further exemplary embodiment, an aircraft with a holder for attaching lines to a support having the above mentioned features is provided.

### BRIEF DESCRIPTION OF THE DRAWINGS

Further details and advantages of the holder of the present invention will be explained in greater detail with reference to the embodiments shown in the accompanying drawings. In the figures:

FIG. 1 shows a first embodiment of a holder in a side view.

FIG. 2 shows an embodiment of a holder in a front view.

FIG. 3 shows a further embodiment of a holder in a front view.

FIG. 4 shows a further embodiment of a holder in a front view.

### DETAILED DESCRIPTION

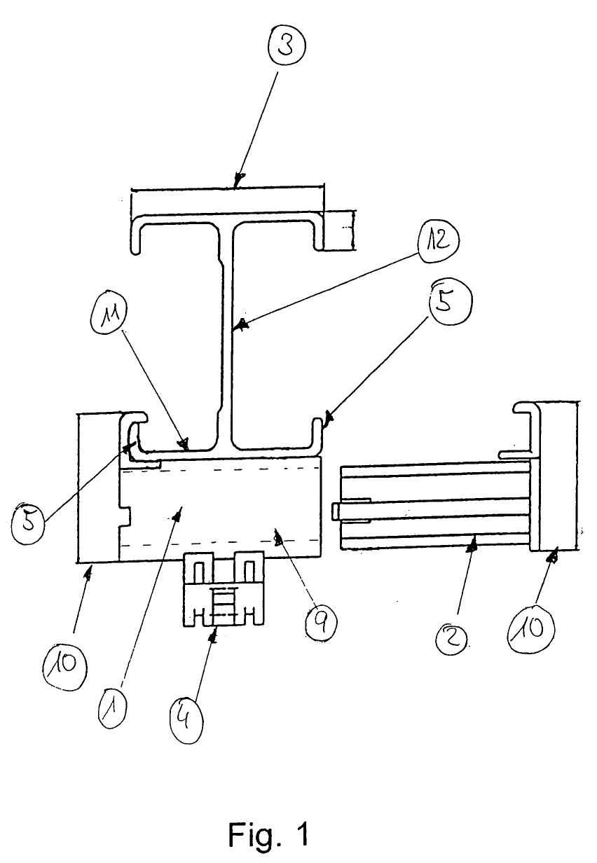

FIG. 1 shows a sectional view of a first embodiment of a holder according to the present invention. According to the invention, the holder may be mounted onto a support, for example, to a double-T support. A double-T support may essentially comprise two horizontal surfaces, the belt 11 and a surface connecting it, the bar 12. Depending on the requirements and specifications, the proportions between the belt 11 and the bar 12 can vary. In any case, such supports may have a surface—for example, the lower horizontal surface, the lower belt 11, can be used for mounting the base body 1. The lower belt 11 of the support has a short, upwardly extending side on its side facing away the bar 12, which connects to the belt 11. This short vertical surface is designated as bar 5. The holder of the present invention, upon mounting, may be placed on the bar 5.

The holder shown in FIG. 1 for attachment of electrical lines to a support 3 in aircraft may have a base body 1. The base body 1 may sit directly on the belt 11 of the support 3. According to one exemplary embodiment of the present invention, the base body 1 and the slide-in unit 2 (or plug-in module) are made substantially of a plastic material. For example, the base body 1 and the slide-in unit 2 can be made in an injection molding method. The base body 1 may essentially have a flat structure. Its size can be varied depending on the lines to be laid. Above, the surface of the base body 1 can be defined by the bordering belt 11 of the support 3, below by the positioned arm 4, in which lines are laid during assembly.

On the lower side of the base body facing away from the support, an arm 4 is located, in which the lines can be placed. The arm supports the lines, which are to be laid. Depending on the thickness or diameter of the lines which are to be laid, base bodies 1 of different sizes can be chosen. The arm 4 may have a round, hook-shaped, upwardly open shape. Different shapes can be used, depending on the composition of the lines. Thus, arms can be used, which have one or more round, hook-shaped, upwardly opened shapes. For placement of more massive lines with a higher net weight, shapes with reinforcements can be selected. Since the base body 1 is defined above by the support 3 and below by the arm 4 for receiving the lines, lines can be placed, which have a maximum diameter, which corresponds to the distance between the top side of the arm 4 and the bottom side of the belt of the support 3. The use of a base body 1 with a greater distance between the arm 4 and the belt or chord 11 makes possible the placement of lines with larger diameters.

The base body 1 may have a recess 9 for receiving the slide-in unit. According to an exemplary embodiment of the invention, the recess 9 runs parallel to the belt 11 of the support 3. The slide-in unit 2 may be inserted into this recess 9.

The slide-in unit 2 may fit as exactly as possible into the recess 9 and may be free of a play. The slide-in unit 2 may comprise two parts, one part that is completely inserted into the recess of the base body, and one part 10, which remains outside of the recess. This part 10, which remains outside of the recess, is placed on the bar 5 of the support, and is adapted in its dimensions to this. Thus, it has a vertical surface, which runs parallel to the bar 5 of the support 3. Two horizontal surfaces, which may be placed exactly above and below the bar 5, terminate at this vertical surface. When the slide-in unit 2 is completely inserted into the recess 9, this device may encompass the bar 5. The upper horizontal surface may terminate exactly over the bar 5 of the support 3, the lower exactly under the arm 5.

Because the part of the slide-in unit 2 is held in the recess 9 of the base body 1 and the other part 10, which remains outside of the recess 9, encompasses the bar 5, the base body 1 is connected firmly with the support 3 after insertion of the slide-in unit 2.

The recess 9 can be formed differently. For instance, it may be an elongated structure, which extends through the base body 1 parallel to the belt 11 of the support 3. By placement of the horizontal surfaces on the bar 5 and the secure hold connected therewith, also a high mechanical stability is achieved, which is necessary in order to hold lines with higher weight.

According to one exemplary embodiment of the present invention, the base body 1 has two recesses 9, through which a slide-in unit 2 can be inserted into the base body 1 from two sides. This can be appropriate, for example, with the mounting of holders to relatively wide supports 3, where it is necessary that two holders be mounted over the width of the support 3, or with very big lines, for which one holder alone does not provide sufficient stability. Alternatively, at the tip of the part of the slide-in unit 2 that is inserted into the recess 9, an additional device can be mounted, which may make possible hooking-together two slide-in units 2, which can be inserted into the recess 9 from two opposite sides until they reach the end position, which further increases stability. This hooking can take place in a further exemplary embodiment by means of a clip fastener 8.

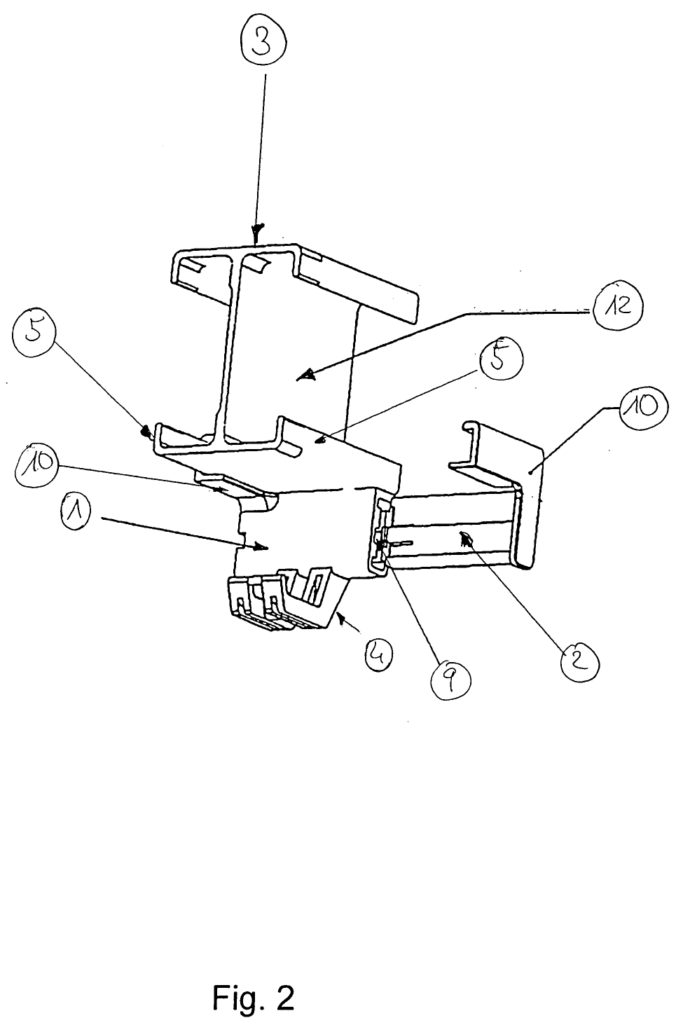

The embodiment shown in FIG. 1 is shown in FIG. 2 in a side view.

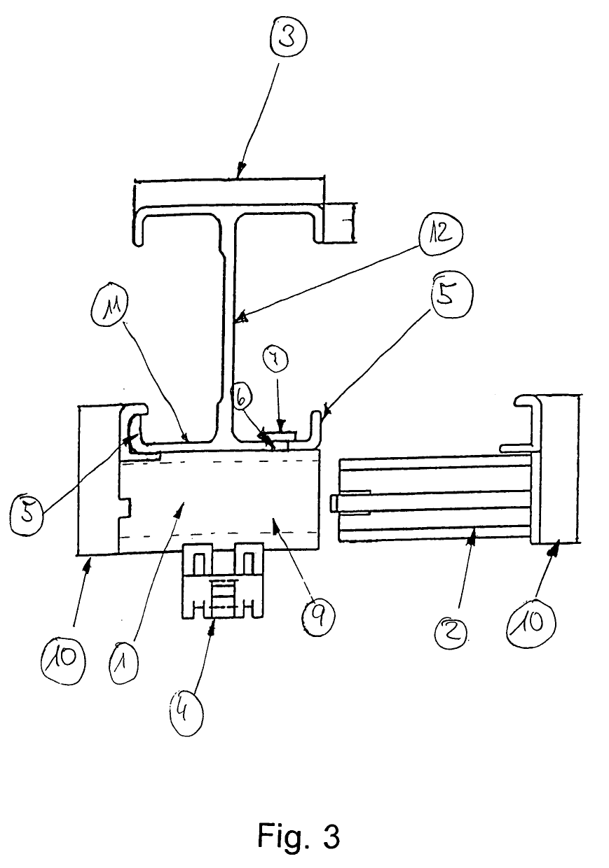

FIG. 3 shows a further embodiment of a holder according to the present invention for fastening electrical lines to a support 3. The basic concept of the holder corresponds to the embodiment of the holder according to FIG. 1. The same parts are provided with the same reference numerals.

In addition to the embodiment of the holder shown in FIG. 1, the base body 1, after it is inserted into an installation bore 6 of the support 3, is connected by means of a pin 7 with the support 3. With this pin 7, an axial displacement of the holder is avoided. The pin is inserted through an installation bore 6, which the belt 11 of the support 3 and the base body 1 have, and after the base body 1 is placed on the belt 11 of the support, such that both bores 6 are aligned exactly with one another. The pin 7 can be made of different materials, preferably from plastic or metal.

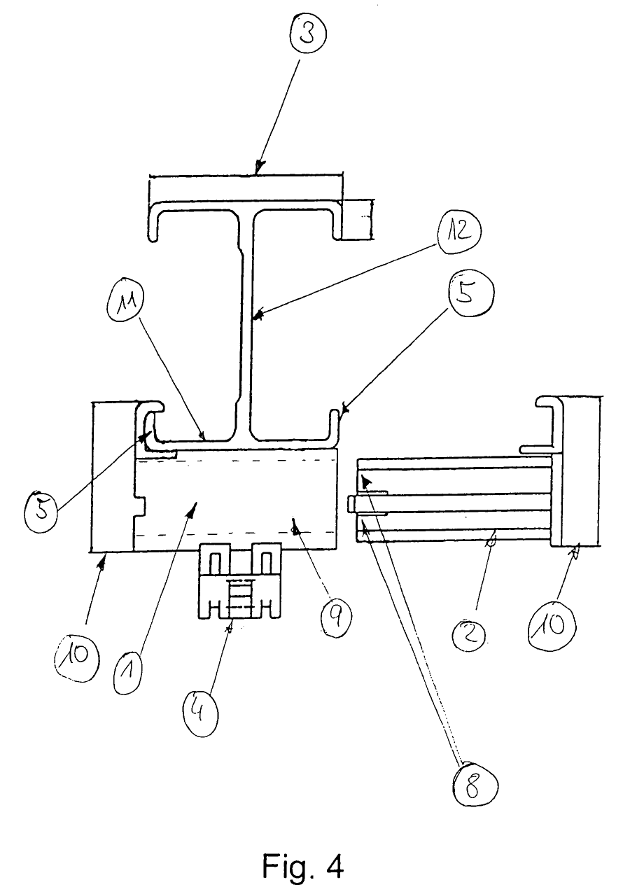

FIG. 4 shows a further embodiment of the holder of the present invention for attaching electrical lines to a support 3. The basic concept of the holder corresponds to the embodiment of the holder in FIG. 1. The same parts are provided with the same reference numerals.

In addition to the embodiment shown in FIG. 1, the slide-in unit 2 is provided with a clip fastener 8. The slide-in unit 2 is inserted into the recess 9 of the base body 1, until it locks at the end with the clip fastener. With this connection, a fast and secure retention of the slide-in unit 2 is guaranteed and unintended slipping-out is avoided. When the part of the slide-in unit 2, which is inserted into the recess of the base body 1, has reached the end position, this clip fastener 8 connects automatically and thereby prevents an unintended slipping-out of the slide-in unit 2. The holder therefore sits fixedly on the support 3. The base body 1 and the slide-in unit 2 encompass the bar 5 of the support 3. In a further embodiment, the possibility exists of opening the clip fastener 8 again by inserting a pointed object, for example, a thin tool into a position provided for that purpose. This is advantageous, then, for example, when a slide-in unit 2 is taken out and is to be replaced by slide-in unit 1 of a different size.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A holder for the attachment of lines to a support in aircraft, the holder comprising:
a base body; and
at least one slide-in unit;
wherein the base body has a recess for receiving the slide-in unit;
wherein the slide-in unit is held in an end position in the recess;
wherein the base body is mountable onto the support by means of the slide-in unit;
wherein the base body is formed to receive lines with a diameter in the order of magnitude of 25 to 50 mm thickness.

2. A holder according to claim 1, comprising:
a pin for engagement into a recess on the support, which pin prevents an axial displacement of the base body.

3. A holder according to claim 1, wherein the slide-in unit is releasably connectable with the base body by means of a clip fastener.

4. A holder according to claim 1, wherein the holder is adapted for fastening lines to a carrier and is essentially made of plastic.

5. A method for mounting a cable holder to a support of an aircraft, wherein the cable holder essentially comprises a base body and a slide-in unit, the method comprising:
mounting the base body to the support by means of a slide-in unit;
inserting the slide-in unit into a recess, which the base body has for receiving the slide-in unit; and
sliding in the slide-in unit into an end position in the recess and retaining the slide-in unit in this end position.

6. A holder for fastening lines to a support in aircraft, the holder comprising:
a base body; and
at least one slide-in unit;
wherein the base body has a recess for receiving the slide-in unit;
wherein the slide-in unit is held in an end position in the recess;
wherein the base body is mountable to the support by means of the slide-in unit;
wherein the base body is formed to receive lines having a diameter in the order of magnitude of 30 to 50 mm thickness in an arm.

7. An aircraft including a cable holder for the attachment of lines to a support in aircraft, the holder comprising:
a base body; and
at least one slide-in unit;
wherein the base body has a recess for receiving the slide-in unit;
wherein the slide-in unit is held in an end position in the recess;
wherein the base body is mountable onto the support by means of the slide-in unit;
wherein the base body is formed to receive lines with a diameter in the order of magnitude of 25 to 50 mm thickness.
